(19) United States
(12) Patent Application Publication
(10) Pub. No.: US 2006/0136246 A1
(43) Pub. Date: Jun. 22, 2006

(54) Hierarchical program guide

(76) Inventor: Edgar A. Tu, Castro Valley, CA (US)

Correspondence Address: FROMMER LAWRENCE & HAUG, 745 FIFTH AVENUE- 10TH FL., NEW YORK, NY, 10151, US

(21) Appl. No.: 11/021,347

(22) Filed: Dec. 22, 2004

(51) Int. Cl. G06Q 99/00

(52) U.S. Cl. 705/1

(57) ABSTRACT

Methods and apparatus for implementing a hierarchical content guide. In one implementation, a method of selecting a scheduled content item includes: selecting a first level content item from a first list of content items; selecting a second level content item from a second list of content items, wherein said second list corresponds to said selected first level content item and said selected second level content item indicates scheduled content data having a scheduled time; accessing said content data at said scheduled time.

### BACKGROUND

Graphical user interfaces simplify end user interaction with computer programs and are designed such that knowledge of specific commands and/or combinations of keystrokes is not required to efficiently and effectively use the computer program. Thus, a function can be carried out by the computer application, which owns the graphical user interface (GUI), by selecting or clicking with an input device such as a mouse a particular selection available in a GUI.

Graphical user interfaces often attempt to provide as much information as possible to a user. However, space is limited by the size of a display device that a user utilizes, such as a monitor, and/or by the size of an element within the GUI in which information is displayed to the user. Accordingly, techniques have been developed to convey to the end user that additional information logically exists beyond the edges of a window or other elements of the GUI being displayed at any given time. The techniques include a GUI action referred to as “scrolling” in which the displayed information is scrolled to show additional information previously not displayed. In computer terms, scrolling is the ability to move the element(s), displayed within the GUI, left and right or up and down on the display in order to view the element or portion that cannot be included within a single display image.

In a typical window-based GUI system, a group of visually distinct display objects are provided on the display screen, and are commonly referred to as “icons”. Each of the icons represents a function or object, and may be configured as a pointer or symbol connecting the function or object to a file or content. A typical GUI presents data and files as icons in a “desktop” environment using multiple windows containing the icons. A user manipulates the icons and accesses the corresponding data by controlling a pointer displayed in the GUI using a user input device, such as a mouse. The GUI also presents data for opened files in windows and provides selecting and manipulating data in opened files through actions of the pointer. The user can then scroll the content of windows to display various portions of the data or groups of icons.

One type of GUI is a program guide for television programs, sometimes called an “electronic program guide” (EPG). In a typical EPG for television, a listing of programs is displayed in a grid format, with each of multiple rows representing a respective television channel and the programs on that channel. A vertical list of channels is presented on the left side of the grid. Horizontal time demarcations across the top side of the grid show when the displayed programs are scheduled to be available (e.g., by broadcast). Each program is enclosed in a box matching the row for the program's channel and the relative time demarcations for the program's time. Hence, in the typical grid EPG, multiple programs for each of multiple channels are simultaneously shown in respective horizontal rows. A user can scroll through the EPG to show more information, scrolling up and down to see more channels and scrolling left and right to see different time periods.

### SUMMARY

The present invention provides methods and apparatus for implementing a hierarchical content guide. In one implementation, a method of selecting a scheduled content item includes: selecting a first level content item from a first list of content items; selecting a second level content item from a second list of content items, wherein said second list corresponds to said selected first level content item and said selected second level content item indicates scheduled content data having a scheduled time; accessing said content data at said scheduled time.

In another implementation, a method of accessing scheduled content data includes: displaying a first list of a plurality of first content items; receiving a selection of one of said first content items; displaying a second list of a plurality of second content items next to said first list, wherein said second list corresponds to said selected first content item; receiving a selection of one of said second content items, wherein said selected second content item indicates scheduled content data having a scheduled time; accessing said content data at said scheduled time.

In another implementation, a method of displaying a hierarchical program guide includes: displaying a channel array as a column of channel icons, each channel icon corresponding to a channel of programs; receiving a selection of one of said channel icons; displaying a time list as a vertical series of time rows, each time row indicating a time and a program, wherein said time list corresponds to the channel corresponding to said selected channel icon so that the time rows displayed indicate programs broadcast on that channel at the indicated times.

In another implementation, a hierarchical program guide interface stored and executed in a multimedia processing device and displayed on a display device includes: a channel array including a plurality of channel icons, each channel icon corresponding to a channel of programs; a program entry list including a plurality of program entries, each program entry indicating a program and having a corresponding time, wherein said program entry list corresponds to a channel corresponding to one of said channel icons so that the program entries displayed indicate programs broadcast on that channel starting at the indicated times.

In another implementation, a multimedia processing apparatus providing a hierarchical program guide interface includes: a display interface to control a connected display device; a television connection to receive broadcast television information and program information; a storage device to store received program information; a processor to control said apparatus; wherein said processor uses received program information to build a hierarchical program guide, said hierarchical program guide including: a channel array including a plurality of channel icons, each channel icon corresponding to a channel of programs; a program entry list including a plurality of program entries, each program entry indicating a program and having a corresponding time, wherein said program entry list corresponds to a channel corresponding to one of said channel icons so that the program entries displayed indicate programs broadcast on that channel starting at the indicated times.

In another implementation, a method of controlling a hierarchical program guide includes: selecting one of a plurality of hierarchical levels in the guide by using left and right directional commands; selecting an item in the selected hierarchical level by using up and down directional commands; wherein items displayed for a lower hierarchical level are determined by a selected item in the immediately upper hierarchical level.

In another implementation, a method of controlling a hierarchical program guide includes: selecting an item in a lower hierarchical level by using up and down directional commands; selecting an item in an upper hierarchical level by using left and right directional commands; wherein items displayed for said lower hierarchical level are determined by the selected item in said upper hierarchical level.

### BRIEF DESCRIPTION OF THE DRAWINGS

FIG. 1 shows one implementation of a multimedia processing system.

FIG. 2 is a functional block diagram showing one implementation of a multimedia processing apparatus.

FIG. 3 illustrates one implementation of a display of a menu screen generated by the multimedia processing apparatus.

FIG. 4 illustrates one implementation of a display screen of a hierarchical program guide.

FIGS. 5-7 illustrate alternative implementations of display screens hierarchical program guides.

FIG. 8 shows a flowchart illustrating one implementation of using a hierarchical program guide to record a television program.

### DETAILED DESCRIPTION

The present invention provides methods and apparatus for implementing a hierarchical content guide. In one implementation, a graphical user interface in a multimedia system provides access to program information according to a schedule of times and channels through two vertically scrolling lists: one of channels, and one of programs indexed by time. A user selects a channel from the list of channels and then the system displays the list of programs for that channel, arranged by time. The user can then select a program for viewing or recording, or to obtain supplemental program information.

As used in this disclosure, the term “content” can refer to audio and/or video, such as still or moving images, music, games, text, or combinations thereof, as well as to the corresponding data. The term “media” can refer to means for carrying or transmitting information, such as hard disks, optical disks, memory cards, and broadcast lines, and can represent data formats such as compression formats.

Several illustrative examples of implementations are presented below. These examples are not exhaustive and additional examples and variations are also described later.

In one example, a media system provides a cross-based hierarchical graphical user interface to select media items available for presentation and manipulation through the system. The media system displays on a connected television a horizontal row of icons as a list of categories (e.g., music, video, games, television programs, stored data) at mid-screen and an intersecting vertical column of icons as a list of items in a selected category. A user selects a category by moving a selection box along the row of icons using a joystick or pad in a control device (alternatively, the selection area is stationary and the icons scroll). When the user selects an icon in the row, the system displays the column of icons for that selected category icon. The combination of the intersecting row and column of icons creates the cross-shape.

One category is television programs. When the user selects the television program category icon, the system displays a vertical column of icons corresponding to respective television channels. The user selects a channel by moving a selection box along the column of icons, similar to selecting a category. When the user selects one of the channel icons, the system displays a vertical list of times and programs corresponding to the selected channel. The user selects a program by moving a selection box among the list of programs. When the user selects a program, the system displays options (e.g., at the bottom of the screen) available with corresponding buttons to press to access the options, such as to display additional information about the program by pressing button 1, to begin displaying the program (if it is available) by pressing button 2, or to record the program (e.g., store the audio and video data for the program in storage of the system) by pressing button 3.

In another example, the media systems displays the guide as a full-screen of information. When the user selects the television program icon from the horizontal row of category icons, the media system displays a new program guide screen. The media system displays a vertical column of channel icons on the left side of the display screen. One of the channel icons is selected by default. The user selects a channel by moving the selection box to another channel along the column of icons. For the selected channel icon, the system displays a vertical list of times and programs corresponding to the selected channel. Because the system uses the full screen for the guide, the system can display more information about each program displayed, such as additional information about the content of the program.

In this way, a media system presents a guide of television programs in a vertically-oriented hierarchical interface. A user can easily cause the system to display what programs are available on a particular channel through simple selections of icons. In addition, the user can then perform operations based on that selection (e.g., recording). The selection and presentation is quick and intuitive.

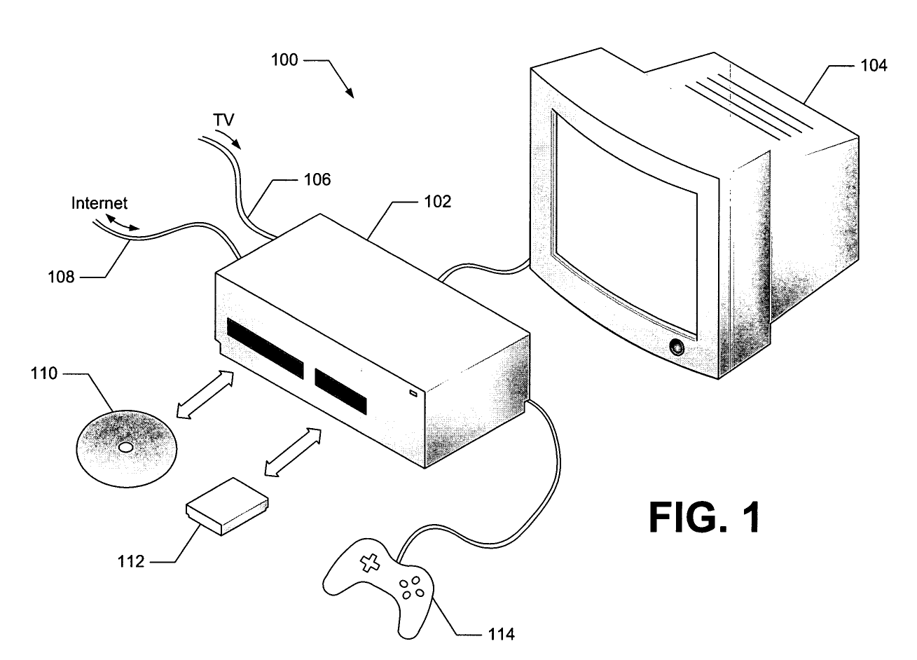

FIG. 1 shows one implementation of a multimedia processing system 100, which includes a composite apparatus capable of processing content (e.g., still images, moving images, music, broadcasts, and games), stored in corresponding media. The processing of content includes presentation, recording, and other related tasks performed by the multimedia processing system 100. The multimedia processing system 100 includes a multimedia processing apparatus 102, a display 104 (e.g., a monitor or television), and a controller 114 (e.g., a game controller).

The multimedia processing apparatus 102 receives multimedia content from various sources, such as broadcast media, the Internet media, an optical disk 110 (e.g., a CD or DVD), and a memory card 112 (e.g., a Memory Stick™ offered by Sony Corporation). Other sources and connections can also be provided, such as a wireless receiver. Content from the broadcast media can be received through line 106 (e.g., connected to a CATV system), while content from the Internet media can be received through line 108 (e.g., connected to a cable modem supporting a broadband Internet connection). The content from the broadcast media and the Internet media can be recorded and stored by the multimedia processing apparatus 102. The received content can also be used by various functions (e.g., a game) of the multimedia processing apparatus 102.

The multimedia content are displayed on the display 104. The controller 114 allows the user to input various instructions related to multimedia processing, and to control functions of the multimedia processing apparatus 102.

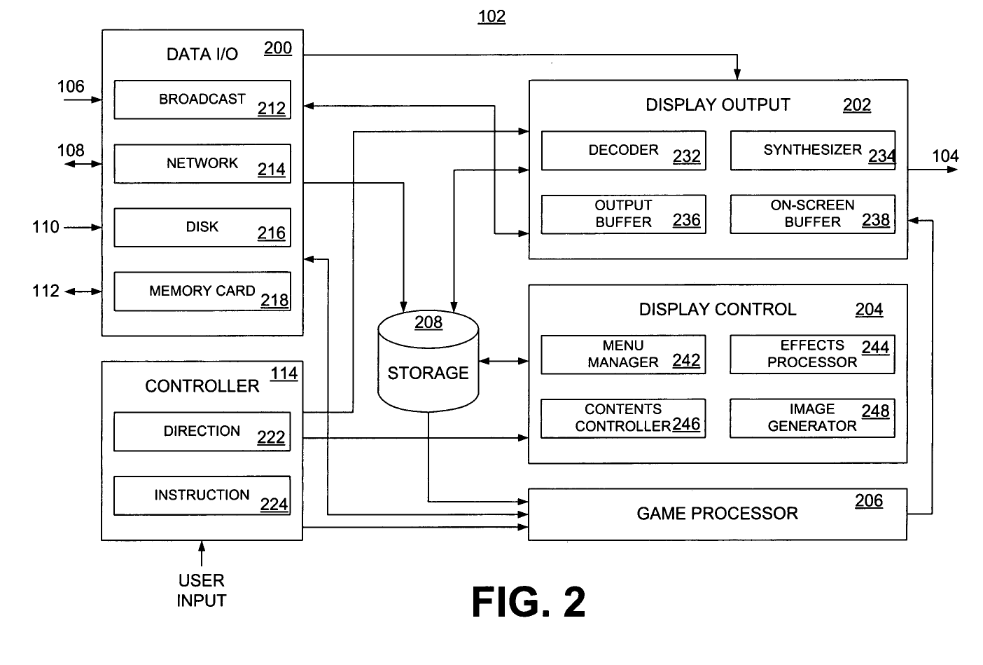

FIG. 2 is a functional block diagram showing one implementation of the multimedia processing apparatus 102. In the illustrated implementation, the multimedia processing apparatus 102 includes the controller 114, a data input/output (I/O) unit 200, a display output unit 202, a display control unit 204, a storage unit 208 (e.g., a HDD), and a game processor 206 (e.g., providing functionality similar to that of a PlayStation2™ offered by Sony Computer Entertainment, Inc.). The multimedia processing apparatus 102 further includes programs and instructions for supporting the hierarchical program guide discussed below and for performing various other functions, such as a data input function, a data retaining function, an image processing function, a rendering function, and other related functions.

The controller 114 includes a direction-determining unit 222 for determining one or a combination of four directions (i.e., up, down, left, and right) from the user input, and an instruction-determining unit 224 for determining an instruction from the user input. The instruction may include a command to present a multimedia content, to terminate the presentation, to invoke a menu screen, and to issue other related commands and/or instructions. Output of the controller 114 is directed to the display output unit 202, the display control unit 204, and the game processor 206.

In the illustrated implementations of FIGS. 1 and 2, the direction-determining unit 222 and the instruction-determining unit 224 are configured with a combination of buttons, circuits, and programs to actuate, sense, and determine the direction and the instruction. The buttons can include cross-shaped keys or joysticks. The button associated with an instruction for invoking a menu screen can be set in a toggle manner so that the menu screen can be toggled between a display mode and a non-display mode each time the button is pressed. The command or request associated with particular input (e.g., a particular button press) can be context-sensitive. For example, pressing a button while video is being displayed causes the video to play backwards (rewind), and pressing the same button while one of a series of still images is being displayed causes the previous image to be displayed.

In one implementation, the direction-determining unit 222 may determine the diagonal movements of the button as a binary command in which the movement is ascertained to be in one of two directions. Thus, a diagonal movement between the up direction and the right direction can be ascertained to be in either the up or the right direction. In another implementation, the direction-determining unit 222 may determine the diagonal movements of the button as an analog command in which the movement is ascertained to be in a particular direction up to the accuracy of the measurement. Thus, a diagonal movement between the up direction and the right direction can be ascertained to be in a northwesterly direction.

The data I/O unit 200 includes a broadcast input unit 212 for inputting broadcast content via the television line 106; a network communication unit 214 for inputting and outputting data such as web content via the Internet line 108; a disk reading unit 216 for inputting data stored on a disk 110; and a memory card reading unit 218 for inputting and outputting data to/from a memory card 112. Output of the data I/O unit 200 is directed to the display output unit 202, the display control unit 204, the game processor 206, and the storage unit 208.

The display output unit 202 includes a decoder 232, a synthesizer 234, an output buffer 236, and an on-screen buffer 238. The decoder 232 decodes input data received from the data I/O unit 200 or the storage unit 208. Thus, the input data may include broadcast content, movie, and music. The synthesizer 234 processes the decoded input data based on user direction/instruction received from the controller 114. The output of the synthesizer 234 is stored in the output buffer 236. The on-screen buffer 238 stores image data of the menu screen generated by the display control unit 204. The output of the display output unit 202 is transmitted to the display 104.

The display control unit 204 includes a menu manager 242, an effects processor 244, a content controller 246, and an image generator 248. The menu manager 242 manages media items and multimedia content received from the storage unit 208 and the data I/O unit 200, and shown on the menu screen. The menu manager 242 also manages the operation of the hierarchical program guide, including building the channel and program lists and entries based on received program information. The effects processor 244 processes operation of icons and icon arrays on the menu screen. The effects processor 244 also manages various actions and effects to be displayed on the menu screen. The content controller 246 controls processing of media items and multimedia content, and handling of data from the data I/O unit, the storage unit 208, and the game processor 206. The image generator 248 operates to generate a menu screen including a category icon array and a content icon array and the display of the hierarchical program guide.

The game processor 206 executes a game program using data read from the data I/O unit 200 or from the storage unit 208. The game processor 206 executes the game program based on user instructions received from the controller 114. The display data of the executed game program is transmitted to the display output unit 202.

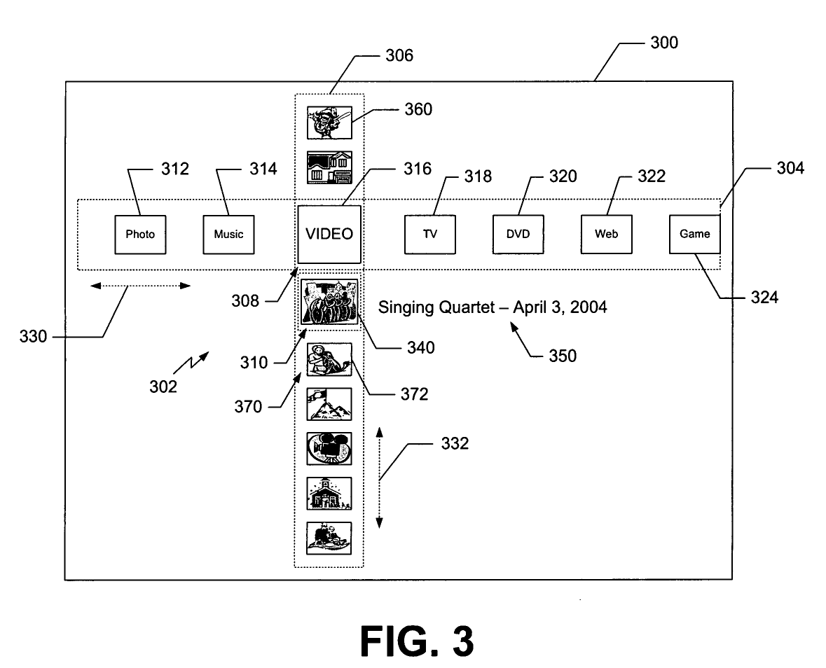

FIG. 3 illustrates one implementation of a display 300 of a menu screen 302 generated by the multimedia processing apparatus 102. The menu screen 302 is accessed by inputting a menu screen command, such as by pressing an appropriate button on the controller 114. The menu screen closes (is hidden) when a content item is selected and accessed (e.g., when a movie is selected and played).

The display 300 illustrates the menu screen 302 in a two-dimensional array. In the illustrated implementation, the menu screen 302 is displayed as a cross shape. In other implementations, the menu screen can be displayed in any shape and in any number of dimensions.

The two-dimensional array includes a category icon array 304 arranged as a row in a horizontal direction, and a content icon array 306 arranged as a column in a vertical direction. In other implementations, the arrays 304, 306 can be arranged in different directions. Thus, the category icon array 304 and the content icon array 306 intersect near the center area 308 of the menu screen 302. The category icon array 304 includes a plurality of category icons. The content icon array 306 includes a plurality of content icons. The icons can be provided by the apparatus, selected by a user, or retrieved from media.

In FIG. 3, the category icon array 304 includes a photograph icon 312, a music icon 314, a moving image icon 316, a television program icon 318, an optical disk icon 320, a web icon 322, and a game icon 324. In other implementations, the category icon array 304 can include other related icons, such as a streaming media icon or a network icon. These icons represent types of content or other data available for processing in the multimedia processing apparatus 102.

The category icons 312-324 can be moved or scrolled across the menu screen 302 (e.g., see 330) by horizontally moving the button/joystick on the controller 114. A particular category icon, for example, a video icon 316 in FIG. 3, can be selected by moving the icon 316 into the center area 308 of the menu screen 302. The category icon 316 is enlarged when the icon 316 is moved into the center area 308 indicating the selection of a type of content, which in this illustrated example is video. In another implementation, the selection can be made by moving the icon to an area other than the center area or by moving a pointer over the icon and clicking a button to select the icon. In a further implementation, the color of the selected medium icon can be changed to a color different from those of other medium icons in the medium icon array. In another implementation, the selected medium icon can be made to flash so that the selected icon can be easily distinguished from other icons.

The effects processor 244 in the display control unit 204 manipulates the category icon array 304 in the menu screen 302 by scrolling the category icons in a horizontal direction. The category icons 312-324 in the category icon array 304 are organized in a circular database, and so every category icon in the category icon array 304 can be selected and displayed by the effects processor 244 by continuously scrolling in one direction. For example, although the photo icon 312 is to the left of the center area 308 of the menu screen, the photo icon 312 can be moved into the center area 308 by continuously scrolling left. Alternatively, the category icons can be arranged in a linear list (i.e., having an end to the list, so that continuous scrolling in one direction will not return to the same point in the list).

As described above, the effects processor 244 displays the category icons with the same display parameters while the icons are being scrolled. However, when a category icon is moved into and fixed in the center area 308 of the menu screen 302 (e.g., remains in place for more than a defined time period), the effects processor 244 may change the display parameters for easy viewing. The display parameters can include color, size, lightness, saturation, and/or hue. The display parameters can also include special effects, such as a flashing or blinking action.

In FIG. 3, the video content array 306 is displayed by moving the video icon 316 into the center area 308 of the menu screen 302. The selection of other category icons displays content icon arrays for other content files. In FIG. 3, the video content icon array 306 includes thumbnail icons of video content files stored in the storage unit 208. When a different category icon is selected, a different content icon array will be displayed. Thus, by moving a particular category icon into or out of the center area 308, a full set of the content icons relating to that particular category icon can be fully extended or retracted.

Although FIG. 3 shows the video icon 316 as the selected icon, other category icons 312-314, 318-324 can be selected to process/view other types of multimedia content. For example, the photo icon 312 can be selected when a stored image is to be processed or viewed. Thus, the content icon array may include thumbnail icons of still images or small moving images taken with a digital camera. The music icon 314 can be selected when audio files are played or processed. The audio files are typically read in from the optical disk 110 in a specific compression format. Thus, the content icon array may include thumbnail icons of songs or albums. Information such as a title of the song or album can be displayed adjacent to the selected icon. Other attributes that can be displayed include the duration of the song or album.

The TV icon 318 can be selected when a television program received from the TV line 106 is to be viewed or processed. The content icon array may include thumbnail icons of broadcast channels and/or programs. Attributes of the television program such as a name/number of the broadcast channel, a title of the program, and a broadcast time can be displayed. As described below, in one implementation, selecting the TV icon 318 accesses a hierarchical program guide and causes an array of channel icons to be displayed.

The DVD icon 320 can be selected when video and/or audio stored on the optical disk 110 is to be viewed and/or listened to. When the optical disk 110 is recognized as a DVD, a legend “DVD” is displayed on the category icon 320. Otherwise, when the optical disk is recognized as a CD, a legend “CD” is displayed on the category icon 320. In one implementation, when a moving image is stored on the DVD or the CD, a thumbnail of a short video clip can be used as a content icon. In another implementation, when music is stored on the DVD or the CD, an icon representing a short audio clip of the music can be used as a content icon.

The Web icon 322 can be selected when data from the Internet line 108 is to be processed or displayed. Thus in this case, the content icon array may include thumbnail icons of Web sites or links. Attributes of the Web sites such as a URL of the Web site can be displayed adjacent to the selected icon.

The game icon 324 can be selected when a game program is to be played or executed. Thus in this case, the content icon array may include thumbnail icons of different game programs. Attributes of the game program such as a title of the game can be displayed adjacent to the selected icon.

In general, the thumbnail content icons are still images representing the linked content files. However, the thumbnail icons can be a sequence of animated images, which may provide better representation of the content files. In one implementation, the content icons are retrieved from data of the content files (e.g., from thumbnail data stored with the content data).

In FIG. 3, when the video content icon array 306 is in a fully extended mode, the array 306 includes eight visible video content icons representing eight video content files. In some implementations, the number of visible content icons can be appropriately varied. Additional video content icons representing other video content files can be made visible by scrolling the icons up or down, as shown at 332 (icons scroll “under” the category icon in the center area 308). Similar to the category icon processing, the effects processor 244 displays the video content icons with the same display parameters while the icons are being scrolled. However, when a particular video content icon 340 is positioned into an attention area 310, below the center area 308, the effects processor 244 changes the display parameters of the particular video content icon 340 for easy viewing. In other implementations, the attention area 310 can be positioned at anywhere in the content icon array 306.

The effects processor 244 enlarges the content icon when the icon is positioned into the attention area 310. The display parameters can include color, size, lightness, saturation, and/or hue. The display parameters can also include special effects, such as a flashing or blinking action. Further, when the video content icon 340 is positioned into the attention area 310, attributes 350 associated with the icon 340 are displayed adjacent to the icon. For example, in one implementation, the attributes 350 can include a title and a recording date.

When the controller 114 provides a command/instruction to select a particular content icon or thumbnail 340 (e.g., by entering a select or play command while the icon 340 is positioned in the attention area 310), the image generator 248 in the display control unit 204 removes the menu screen 302 from the display 300. Substantially simultaneously, the content controller 246 in the display control unit 204 initiates the display of the content file linked to the selected content icon 340. In the illustrated implementation, the selected content file is the Singing Quartet video.

In one implementation, the commands available for an icon in the attention area 310 depend on what that icon represents. One or more available commands are displayed at the edge of the screen 302 along with corresponding operations to select the commands (e.g., button labels to push). In another implementation, the available commands are displayed on request, such as in response to a help command or button press.

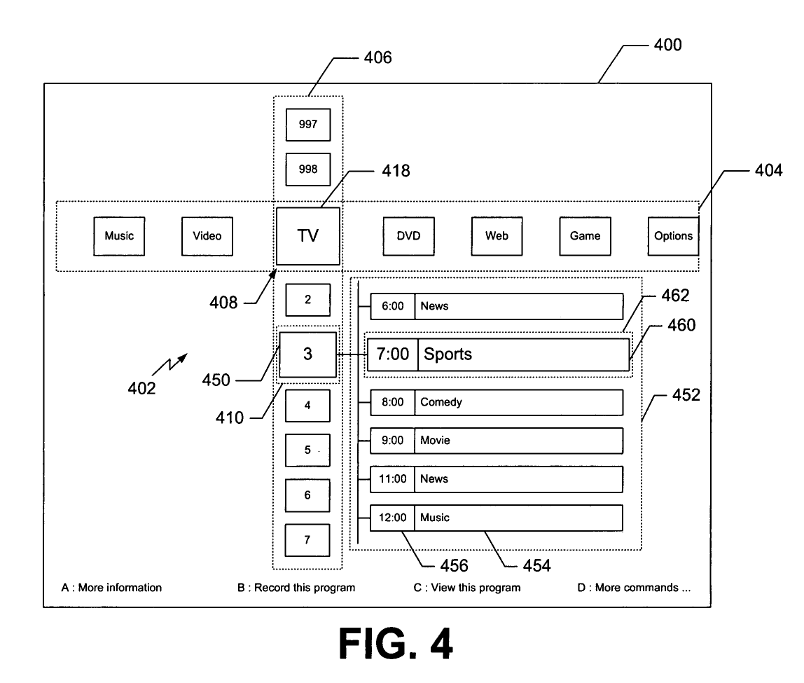

FIG. 4 illustrates one implementation of a display screen 400 of a hierarchical program guide. The hierarchical program guide is part of the GUI provided by the multimedia processing apparatus 102. This hierarchical program guide displays the programs scheduled to be presented at indicated times for a selected channel. The hierarchy is defined by the relationship between channel and time: the channel is the first layer, and the times are the second layer. A user accesses the guide by selecting the television category icon 418 in the category icon array 404. The display and GUI operation of the icons and lists in the guide are similar to that described above referring to FIG. 3 (e.g., the effects processor 244 manages scrolling).

The guide displays a channel array 406 including a series of channel icons corresponding to respective channels of programming received by the multimedia processing apparatus 102 through the television line 106. For a selected channel icon 450 in an attention area 410, the guide displays a program entry list 452 including a series of program entries 454 and corresponding program times 456. A program entry 454 provides the name of a television program that will be available (e.g., broadcast for viewing) on the channel corresponding to the selected channel icon 450 at the time indicated by the program time 456 corresponding to that entry 454. For example, in FIG. 4, the guide indicates that a news program will be presented at 6:00 on channel 3, a sports program will be on at 7:00 on channel 3, and so on. The multimedia processing apparatus 102 receives the program and time information to build the guide through the television line along with the television program data or signals (e.g., using extra bandwidth). Alternatively, the multimedia processing apparatus 102 receives the program and time information from another source, such as through the Internet or a phone line. In one implementation, the multimedia processing apparatus uses the database and data access techniques discussed in U.S. patent application Ser. No. 10/874,863, entitled “FAST SCROLLING IN A GRAPHICAL USER INTERFACE,” to store the program information and support the program guide to promote fast scrolling of the arrays and lists in the guide.

The user can scroll the program entry list 452 up or down to display more program entries and times (e.g., scrolling up to display program entries with earlier times and scrolling down to display program entries with later times) using the directional pad of the controller 114. To change the channel for which program entries are displayed, the user presses the directional pad to the left (moving the focus from the program entry list 452 left to the channel array 406) and then scrolls the channel array 406 up and down to position a desired channel icon in the attention area 410.

The user can select a program entry 460 by scrolling the program entry to a program select area 462. The user has several commands available for operations to perform regarding the selected program entry 460. In FIG. 4, four commands are shown at the bottom of the display screen 400: “More information,” “Record this program,” “View this program,” and “More commands . . . ”. For each command, a corresponding button on the controller 114 is indicated: button “A” for the “More information” command, and so on. In this example, pressing the A button will cause the multimedia processing apparatus 102 to display more information about the program corresponding to the program entry 460 in the program select area 462, such as a summary of the program or names of people appearing in the program. Pressing the B button will cause the multimedia processing apparatus 102 to record the selected program, such as by storing the video data for the program in the storage device 208 when the data is received through the television line 106 at the scheduled time for the program. Pressing the C button will cause the multimedia processing apparatus 102 to view the selected program if the selected program is currently available (i.e., if the program is currently being broadcast). In one implementation, the GUI does not display the “View this program” command if the selected program is not currently available (e.g., because the current time is before the program is scheduled to start). Pressing the D button will cause the multimedia processing apparatus 102 to display additional commands available in a new screen or window (e.g., allowing a user to select a command by scrolling through the list of additional commands). In other implementations, different commands can be displayed for the selected program. Alternatively, the commands are not displayed, but will still be accepted (e.g., relying upon the user to know what commands are available). In another implementation, entering a select command will cause the GUI to present a scrolling list of commands available for the selected program. In one implementation, the GUI displays the list of available commands as another hierarchy layer as a command array to the right of the selected program entry.

In another implementation, the GUI presents the hierarchical program guide in a full-screen mode. In this case, the user selects the television category icon 418 in the category icon array 404 and enters a display command (e.g., by pressing a defined button on the controller 114, as indicated by information displayed at the bottom of the screen). In response, the GUI removes the menu screen and displays the channel array on the left side of the screen and the program entry list for the channel in the attention area next to the channel array. By using the full screen, the GUI can display more channels and more programs for a selected channel. In addition, the GUI can display more information about each program or a selected program without obscuring other parts of the program guide.

In one implementation, the full-screen hierarchical program guide can be accessed while a television program is being viewed. The user enters a defined command (e.g., pressing a “guide” button on the controller 114) and the GUI presents the guide as a transparent overlay on top of the currently viewed television content. Alternatively, the television content is reduced to a portion of the screen, such as a quarter screen image, while using the remainder of the screen for the guide.

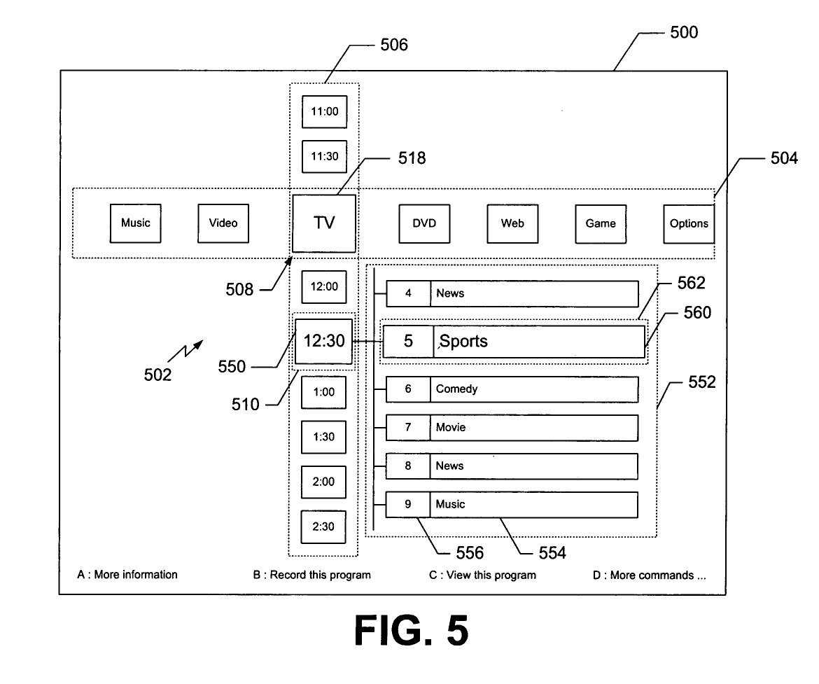

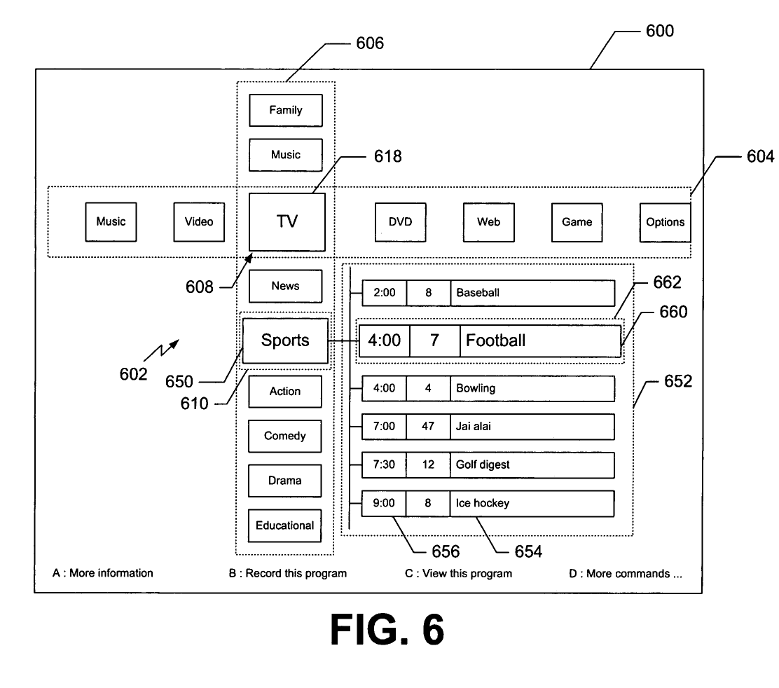

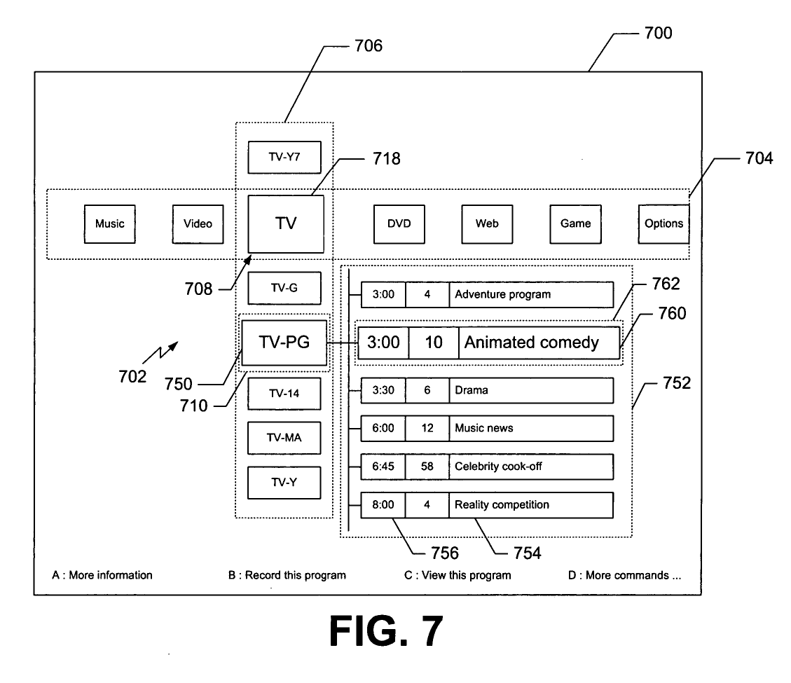

The program guide can be organized in different hierarchies as well. In FIG. 4, the guide is presented in two layers: channels and then programs by time. FIG. 5 illustrates one implementation of a display screen 500 of a hierarchical program guide presenting the guide information by time and then by channel. FIG. 6 illustrates another implementation of a display screen 600 of a hierarchical program guide presenting the guide information by genre (action, drama, news, etc.) and the time and channel. FIG. 7 illustrates another implementation of a display screen 700 of a hierarchical program guide presenting the guide information by program rating (e.g., TV-Y, TV-Y7, TV-G, TV-PG, TV-14, TV-MA, G, PG, PG-13, R, etc.) and then by time and channel. Of course, the information shown in the guides in FIGS. 4-7 is illustrative and different channel, time, program, etc. information can be presented in various implementations. Other organizations include, but are not limited to: time and then programs by network name, person (e.g., actor, director, etc.) and then by time and channel, genre then channel and then programs by time (three layers), genre then time and then programs by channel. The organization can also be combined with stored content (e.g., time and channel reflecting original aspects of recording, or being omitted). The user can control which organization is used through settings or preferences in the GUI. Using various organization configurations, other stored content and data can be accessed through hierarchical guide as well, such as video games organized by genre and/or rating.

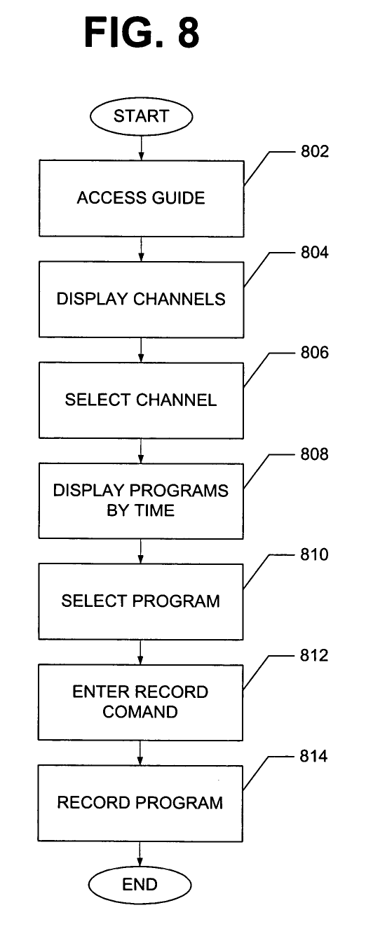

FIG. 8 shows a flowchart illustrating one implementation of using a hierarchical program guide to record a television program. Initially, a multimedia processing system (e.g., as shown in FIG. 1) is connected to a television broadcast system (e.g., a CATV system) and receives television programs and guide information (channel, program, and time information) from the television system. In one implementation, the multimedia processing apparatus builds a database of program information using the received guide information and periodically updates the database as new information is received. The multimedia processing system supports a GUI providing the cross-based selection system described above and providing a hierarchical program guide. A user has caused the GUI to display the menu screen (e.g., as shown in FIG. 3) by pressing a “GUI” button on a controller.

The user selects the hierarchical program guide through the GUI, block 802. As discussed above, the GUI displays a category icon array as a horizontal row of icons (the GUI executing as software running on the multimedia processing apparatus causes operations to occur). The user causes the category icons to scroll left or right to position the television category icon in the selection area for the array (e.g., the center area 308 in FIG. 3). When the television category icon is positioned in the selection area for a predetermined period (e.g., more than 1 second), the GUI opens the program guide. In another implementation, the user selects the television icon by positioning the icon in the selection area and pressing a select button on the controller, or placing a pointer or indicator over the television icon. In another implementation, the user accesses the guide by pressing a “guide” button on the controller.

The GUI displays the channel array of icons as the first layer of the hierarchical program guide, block 804. As shown in FIG. 4, the GUI displays the channel icons in a vertical column, in ascending order, wrapping the series of icons back to the top of the column as the icons scroll up and down.

The user selects one of the channels, block 806. The user scrolls the icons in the channel array up and down using the directional controls of the controller. In other controller implementations, the user can press directional buttons or turn a wheel to scroll the icon array. To select a channel, the user scrolls the icons to position the channel icon corresponding to the desired channel in a selection area of the channel array (e.g., the attention area 450 in FIG. 4). Once the icon has been in the selection area for a predetermined period, the channel is selected. In another implementation, the user selects a channel by pressing a select button or placing a pointer or indicator over a channel icon. In one implementation, the user presses the right directional button to select the channel in the selection area and open the next level of the hierarchy.

The GUI displays a list of programs by time for the selected channel, block 808. The GUI retrieves program information for the selected channel from the storage device of the multimedia processing apparatus. The GUI builds program entries for the programs available on that channel for a defined time period (e.g., for a 24 hour period beginning two hours before the current time). In another implementation, the multimedia processing apparatus builds and maintains the program entries on a regular basis (e.g., once each day). The GUI displays the program entries in a vertical list that can be scrolled up and down, similar to the icon arrays (e.g., as shown in FIG. 4). Each program entry shows the name of the program and also has a corresponding time presented next to the entry (or in the entry). The displayed time indicates the start time of the program (i.e., when the program is scheduled to be received by the multimedia processing apparatus). Alternatively, the start and stop times are both shown. The program entries are arranged in ascending order of time, so that a program entry that is positioned below another entry has a start time after the upper entry. The user can browse through the programs available on the selected channel by scrolling through the program entries. As the user scrolls to display new program entries, the GUI builds or retrieves new program entries from the received program information.

The user can change the selected channel to display program entries for a different channel by pressing a “back” button on the controller. In one implementation, the left directional button is the back button (the hierarchies are opened to the right and so pressing left is moving back to a higher level), and so pressing the left button causes the focus to move back to the upper level (e.g., from the program entry list to the channel icon array). The back button closes the list of program entries and lets the user scroll the channel icon array again. Alternatively, the lower level remains open and changes to reflect changes in selection at the upper level.

In another implementation, the user can scroll the channel icon array using secondary up and down directional controls without closing the program entry list. As the channel icons move, the GUI displays the program entries for the channel icon currently in the selection area of the channel icon array. In one implementation, the controller includes a directional pad and a joystick. The directional pad controls scrolling of the lowest level array or list being displayed while the joystick controls scrolling of the array or list that is one level higher than the lowest level. For example, while the program entries are displayed in the guide, three levels are being displayed: the category icons, the channel icons, and the program entries. Accordingly, in this context the directional pad will control scrolling the program entries and the joystick will control scrolling the channel icons. In another implementation, the secondary directional controls can be provided as buttons or wheels. In another implementation, an upper level button is provided and while the upper level button is held down, the directional pad controls scrolling at an upper level in the hierarchy.

The user selects one of the program entries, block 810. Similar to selecting a channel, the user scrolls the program entries up and down using the directional controls of the controller to position a program entry in a selection area (e.g., the program select area 462 in FIG. 4). Once the program entry has been in the selection area for a predetermined period, the program is selected.

The user enters a record command, block 812. The GUI displays one or more available commands for the selected program entry at the bottom of the screen. The GUI also indicates what button of the controller to use to perform each command (e.g., “B: Record program” indicating to press the B button to record the selected program). The user presses the button for recording to enter the record command. In other implementations, various command input systems can be used, such as command lists in pop-up windows or command areas, scrolling lists of commands, or default or user-configured mappings of commands to buttons or other input operators of the controller. The controls can also be context-dependent so that the same input can cause a different command to be performed depending on when the input is entered. The GUI causes a recording scheduling task to be set for the multimedia processing apparatus so that the program will be recorded at the scheduled time. The recording task indicates the channel to record from and the start and stop times of the program. After entering the record command, the guide remains open with the same program selected so that the user can view other parts of the guide and issue other commands, if desired.

The multimedia processing apparatus records the program, block 814. The multimedia processing apparatus uses an event scheduler application or service to recognize scheduling tasks, such as recording tasks set by the GUI using the hierarchical program guide. The multimedia processing apparatus has a clock (or receives time information) and compares the current time with the start times of recording tasks. When the current time reaches the start time of a recording task, the multimedia processing apparatus begins recording the program being received from the television system on the channel indicated by that recording task. The multimedia processing apparatus accesses the program from the information received from the television system (e.g., using a tuner and decoder) and stores the data for the recorded program in the storage device for later access by a user (e.g., through the guide or through the video category icon). The multimedia processing apparatus continues to record the information on the channel until the stop time indicated by the recording task.

To perform other operations for a selected program, the user enters other appropriate commands. For example, to begin watching a program that is currently being broadcast from the television system, the user selects the program (by selecting the channel icon and then selecting the program entry) and enters a view command. In response, the GUI closes the guide and begins to display the program. The user can also begin watching a program by selecting a channel icon and then entering a view command (without displaying the program entries for the channel).

In another implementation, the user does not select operations for selected programs, but can request additional information. In this case, the guide is informational about what programs are available.

Some of the commands of the multimedia processing apparatus are context sensitive or dependent. The multimedia processing apparatus provides access to many types of content (music, movies, games, etc.) and the controller has a limited number of buttons. By changing what command is performed in response to a particular button depending on the context when that button is pressed, the flexibility of the controller is enhanced. Similarly, the directional controls or other inputs of the controller can be context-sensitive.

In one implementation, the directional pad controls shifting the focus for selection while the GUI is open and controls the presentation of content according to the type of content. In the GUI the directional pad opens, closes, and scrolls arrays and lists. Initially, when the GUI is opened and the category icon array is displayed as a horizontal row, the left and right directions scroll the category icons. Pressing down opens the content icon array for the category icon in the selection area of the category icon array. Once the content icon array is open, the up and down directions control scrolling the content icon array. In the program guide, the up and down directions scroll the channel icons. If the content icon array does not have a lower level (e.g., it is a flat list of files), pressing left or-right while the content icon array is open causes the category icons to scroll and changes which content icon array is open, depending on which category icon is in the selection area. If the content icon array does have a lower level (e.g., it has folders, or has a hierarchy as in the hierarchical program guide), pressing left or right while the content icon array is open causes the next layer to open corresponding to the content icon in the selection area of the content icon array. In the program guide, pressing the right button while the channel array is open causes the program entries for the channel icon in the selection area to be displayed.

When the lower level has been opened, the up and down directions control scrolling the items in the array or list for the lower level. In the program guide, the up and down directions control scrolling the program entries while the program entries are open. While the lower level is open, pressing the left or right buttons scrolls the array or list one level up. In the program guide, pressing the left button while the program entries are displayed scrolls the channel array up and pressing the right button scrolls the channel array down.

In another implementation, pressing left or right shifts focus between hierarchical layers and pressing up and down scrolls items in the layer that currently had focus. For example, in the hierarchical program guide, when the program entries for a channel are displayed, the left and right directions shift the focus between the channel icon array and the program entry list. The up and down directions scroll either the channel icons or the program entries depending on which layer has focus.

In another implementation, the right directional button causes additional information to be displayed when the currently selected item is at the bottom level of a hierarchy and has no lower level to open. In the program guide, when a program entry is selected (by being positioned in the selection area), pressing right opens additional information for that program.

In one implementation, double-pressing a direction (e.g., quickly pressing a directional button twice) causes a shift to the end of the array or hierarchy. Double-pressing up or down scrolls an array or list to the top or bottom element (for a linear list; or the lowest or highest numbered item in a circular list). Double-pressing left or right shifts focus to the uppermost or lowest layer displayed. Double-pressing left can also be set to close all layers and display only the category icon array.

The directional pad can also control the presentation of content. While music is being played, pressing right or left advances or rewinds the music, skipping forward or backward in the current selection. Pressing up or down changes the selected music t the next track or file in the group from which the current music was selected. Alternatively, left and right change tracks or songs while up and down change albums. While presenting stored video, the directional inputs are similar: left and right for reverse and fast forward, up and down for changing the selected video file (or chapters in a video file, if available). While presenting live video (e.g., television broadcast), up and down can change channels while left and right can control recording of the live video (e.g., left moves backward in the video sequence while the video continues to be recorded, and right moves forward again through the recorded video up to the point of live broadcast again).

The context-sensitive directional control can also be provided through other control inputs, such as groups of buttons (e.g., shoulder buttons on a controller) or a scroll wheel.

The various implementations of the invention are realized in electronic hardware, computer software, or combinations of these technologies. Some implementations include one or more computer programs executed by a programmable processor or computer. For example, referring to FIG. 1, in one implementation, the multimedia processing apparatus 102 includes one or more programmable processors. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Various illustrative implementations of the present invention have been described. However, one of ordinary skill in the art will see that additional implementations are also possible and within the scope of the present invention. For example, while the above description focuses on implementations using television program guides, the scheduling information can be for different types of events as well, such as live event guides or movie theater guides.

In addition, rather than content guides, other scheduling guides can also be used, such as for business hours, or appointment or reservation management and requesting (e.g., displaying a list of providers and then a list of available times for review or selection based on schedule information obtained over the Internet). Accordingly, the present invention is not limited to only those implementations described above.

What is claimed is:

1. A method of selecting a scheduled content item, comprising:
selecting a first level content item from a first list of content items;
selecting a second level content item from a second list of content items, wherein said second list corresponds to said selected first level content item and said selected second level content item indicates scheduled content data having a scheduled time;
accessing said content data at said scheduled time.

2. The method of claim 1, wherein:
said content data is video data for a television program.

3. The method of claim 2, wherein:
accessing said content data includes displaying said television program.

4. The method of claim 2, wherein:
accessing said content data includes recording said television program.

5. The method of claim 2, further comprising:
displaying supplemental information about said television program.

6. A method of accessing scheduled content data, comprising:
displaying a first list of a plurality of first content items;
receiving a selection of one of said first content items;
displaying a second list of a plurality of second content items next to said first list, wherein said second list corresponds to said selected first content item;
receiving a selection of one of said second content items, wherein said selected second content item indicates scheduled content data having a scheduled time;
accessing said content data at said scheduled time.

7. The method of claim 6, wherein:
said content data is video data for a television program.

8. The method of claim 7, wherein:
accessing said content data includes displaying said television program.

9. The method of claim 7, wherein:
accessing said content data includes recording said television program.

10. The method of claim 7, further comprising:
displaying supplemental information about said television program.

11. A method of displaying a hierarchical program guide, comprising:
displaying a channel array as a column of channel icons, each channel icon corresponding to a channel of programs;
receiving a selection of one of said channel icons;
displaying a time list as a vertical series of time rows, each time row indicating a time and a program, wherein said time list corresponds to the channel corresponding to said selected channel icon so that the time rows displayed indicate programs broadcast on that channel at the indicated times.

12. A hierarchical program guide interface stored and executed in a multimedia processing device and displayed on a display device, comprising:
a channel array including a plurality of channel icons, each channel icon corresponding to a channel of programs;
a program entry list including a plurality of program entries, each program entry indicating a program and having a corresponding time, wherein said program entry list corresponds to a channel corresponding to one of said channel icons so that the program entries displayed indicate programs broadcast on that channel starting at the indicated times.

13. The hierarchical program guide of claim 12, wherein:
said channel array is displayed as a vertical column of channel icons;
said program entry list is displayed as a vertical column of program entries to the right of said channel array.

14. The hierarchical program guide of claim 13, wherein:
said channel array is displayed at the left edge of the display area of said display device.

15. The hierarchical program guide of claim 13, wherein:
said channel array is displayed crossing a horizontal row of category icons, and
at the intersection of said channel array and said horizontal row of category icons is a television program category icon.

16. The hierarchical program guide of claim 12, further comprising:
a program category array including a plurality of program category icons, each program category icon representing a category of television program;
wherein said channel array corresponds to a program category corresponding to one of said program category icons so that the program entries displayed correspond to that program category.

17. A multimedia processing apparatus providing a hierarchical program guide interface, comprising:
a display interface to control a connected display device;
a television connection to receive broadcast television information and program information;
a storage device to store received program information;
a processor to control said apparatus;
wherein said processor uses received program information to build a hierarchical program guide, said hierarchical program guide including:
a channel array including a plurality of channel icons, each channel icon corresponding to a channel of programs;
a program entry list including a plurality of program entries, each program entry indicating a program and having a corresponding time, wherein said program entry list corresponds to a channel corresponding to one of said channel icons so that the program entries displayed indicate programs broadcast on that channel starting at the indicated times.

18. A method of controlling a hierarchical program guide, comprising:
selecting one of a plurality of hierarchical levels in the guide by using left and right directional commands;
selecting an item in the selected hierarchical level by using up and down directional commands;
wherein items displayed for a lower hierarchical level are determined by a selected item in the immediately upper hierarchical level.

19. The method of claim 18, wherein:
a first hierarchical level is a list of channels, and
a second hierarchical level is a list of programs.

20. A method of controlling a hierarchical program guide, comprising:
selecting an item in a lower hierarchical level by using up and down directional commands;
selecting an item in an upper hierarchical level by using left and right directional commands;
wherein items displayed for said lower hierarchical level are determined by the selected item in said upper hierarchical level.

21. The method of claim 20, wherein:
said upper hierarchical level is a list of channels, and
said lower hierarchical level is a list of programs.

22. A computer program, stored on a tangible storage medium, for use in selecting a scheduled content item, the program comprising executable instructions that cause a computer to:
select a first level content item from a first list of content items;
select a second level content item from a second list of content items, wherein said second list corresponds to said selected first level content item and said selected second level content item indicates scheduled content data having a scheduled time;
access said content data at said scheduled time.

23. A computer program, stored on a tangible storage medium, for use in accessing scheduled content data, the program comprising executable instructions that cause a computer to:
display a first list of a plurality of first content items;
process a received selection of one of said first content items;
display a second list of a plurality of second content items next to said first list, wherein said second list corresponds to said selected first content item;
process a received selection of one of said second content items, wherein said selected second content item indicates scheduled content data having a scheduled time;
access said content data at said scheduled time.

24. A computer program, stored on a tangible storage medium, for use in controlling a hierarchical program guide, the program comprising executable instructions that cause a computer to:
select one of a plurality of hierarchical levels in the guide in response to left and right directional commands;
select an item in the selected hierarchical level in response to up and down directional commands;
wherein items displayed for a lower hierarchical level are determined by a selected item in the immediately upper hierarchical level.

25. A computer program, stored on a tangible storage medium, for use in controlling a hierarchical program guide, the program comprising executable instructions that cause a computer to:
select an item in a lower hierarchical level in response to up and down directional commands;
select an item in an upper hierarchical level in response to left and right directional commands;
wherein items displayed for said lower hierarchical level are determined by the selected item in said upper hierarchical level.

26. A system for selecting a scheduled content item, comprising:
means for selecting a first level content item from a first list of content items;
means for selecting a second level content item from a second list of content items, wherein said second list corresponds to said selected first level content item and said selected second level content item indicates scheduled content data having a scheduled time;
means for accessing said content data at said scheduled time.

27. A system for accessing scheduled content data, comprising:
means for displaying a first list of a plurality of first content items;
means for receiving a selection of one of said first content items;
means for displaying a second list of a plurality of second content items next to said first list, wherein said second list corresponds to said selected first content item;
means for receiving a selection of one of said second content items, wherein said selected second content item indicates scheduled content data having a scheduled time;
means for accessing said content data at said scheduled time.

28. A system for controlling a hierarchical program guide, comprising:
means for selecting one of a plurality of hierarchical levels in the guide by using left and right directional commands;
means for selecting an item in the selected hierarchical level by using up and down directional commands;
wherein items displayed for a lower hierarchical level are determined by a selected item in the immediately upper hierarchical level.

29. A system for controlling a hierarchical program guide, comprising:
means for selecting an item in a lower hierarchical level by using up and down directional commands;
means for selecting an item in an upper hierarchical level by using left and right directional commands;
wherein items displayed for said lower hierarchical level are determined by the selected item in said upper hierarchical level.
